(19) United States
(12) Patent Application Publication
(10) Pub. No.: US 2014/0379517 A1
(43) Pub. Date: Dec. 25, 2014

(54) Evaluating Benefits of a Product

(71) Applicant: Bank of America Corporation, Charlotte, NC (US)

(72) Inventors: Nisha Gandhi, Somajiguda (IN); Snehal Bathina, West Marredpally (IN); Chaitrali Banerjee, Rajendra nagar (IN)

(21) Appl. No.: 13/922,423

(22) Filed: Jun. 20, 2013

(51) Int. Cl. G06Q 30/06

(52) U.S. Cl. CPC G06Q 30/0631
USPC 705/26.7

(57) ABSTRACT

Systems, methods and apparatuses for quantifying a benefit associated with use of a product or service are provided. In some examples, an entity may receive information about a company to which they are going to attempt to sell a product or service. The methods, computer-readable media and apparatuses may identify a potential improvement at the company, as well as one or more products or services to sell to the company to aid in or provide the improvement. In some examples, the methods, computer-readable media and apparatuses may quantify the impact or benefits associated with use or implementation of the product or service.

### BACKGROUND

In today's competitive work environment, having any advantage in attempting to sell a product or service is advantageous. In conventional sales arrangements, sales associates may discuss one or more benefits associated with the use of a product or service, but it may be difficult to truly convey the advantages to a client or potential client. Accordingly, having information available to present to the client or potential client that quantifies the impact or benefit of using or implementing a product or service may aid in providing a full understanding of the advantages of using the product or service.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, and apparatuses for quantifying an impact or benefit associated with use of a product or service. In some examples, an entity may receive information about a company to which they are going to attempt to sell a product or service. The methods, computer-readable media and apparatuses may identify a potential improvement, benefit or impact at the company. In some examples, the methods, computer-readable media and apparatuses may quantify the impacts or benefits associated with use or implementation of the product or service.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 illustrates an example benefit quantifying system according to one or more aspects described herein.

FIG. 3 is an example method of quantifying impacts or benefits according to one or more aspects described herein.

FIG. 4 is another example method of quantifying impacts or benefits according to one or more aspects described herein.

FIG. 5 illustrates one example table providing a sensitivity analysis according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

Aspects of the arrangements described herein relate to quantifying impacts or benefits associated with a particular product or service being offered (e.g., for sale) to a client or prospective client. In some examples, the benefit quantifying system may aid in identifying a potential cash flow improvement or a discrepancy between a target company (e.g., a company to which the entity is attempting to provide or sell a product or service) and a comparison company (e.g., similar company, competitor, and the like). For instance, the system, method, apparatus, may identify an opportunity to improve cash flow for the target company by providing payment to vendors in a longer period of time and/or receiving payments from customers/clients in a shorter period of time. In some examples, the system may further identify one or more products or services which may aid in or provide the cash flow improvement, reduce or eliminate the discrepancy, and the like. The system, method, apparatus may then quantify the impact or benefit associated with the use of the product or service. For example, a particular cash value, increased interest, percentage increase in working capital, and the like may be identified. This information may then be provided to a target company in order to more clearly describe the impact or benefits of use/implementation of the product/service. Alternatively, the system may identify a negative impact or may identifying multiple impacts or benefits, some negative, some positive, some having a greater impact than others, and the like. These and various other aspects will be described more fully below.

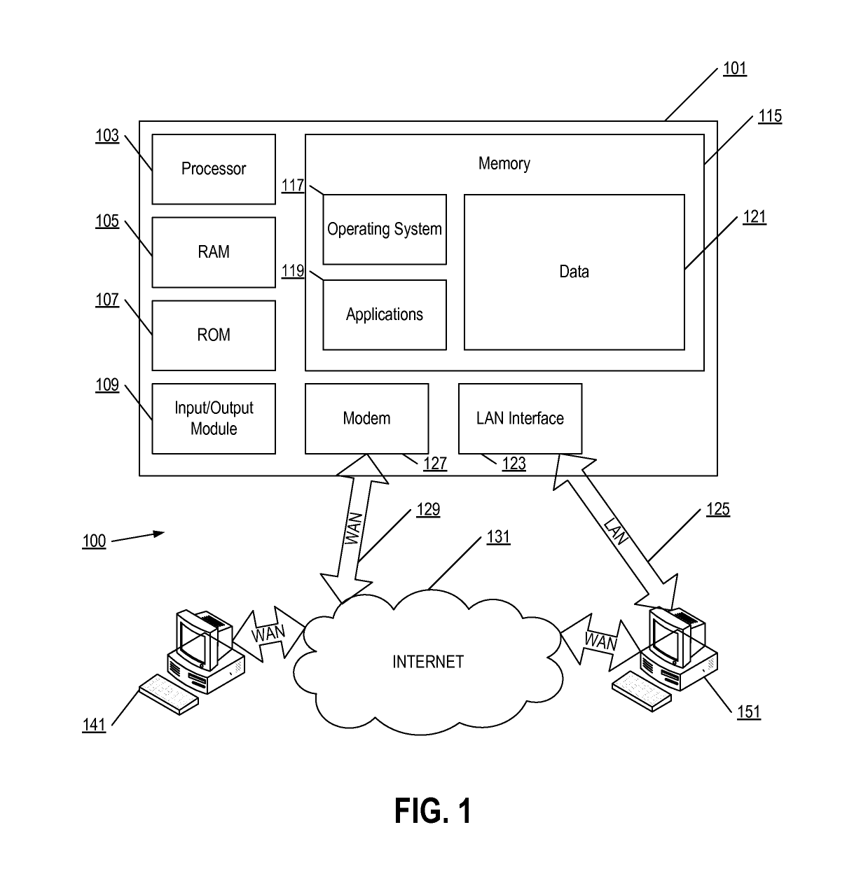

FIG. 1 illustrates an example block diagram of a generic computing device 101 (e.g., a computer server) in an example computing environment 100 that may be used in one or more illustrative embodiments of the disclosure. For example, the generic computing device 101 may correspond to a server in benefit quantifying system, as described in examples below. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mobile device, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1 include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, tablet computers, and the like) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

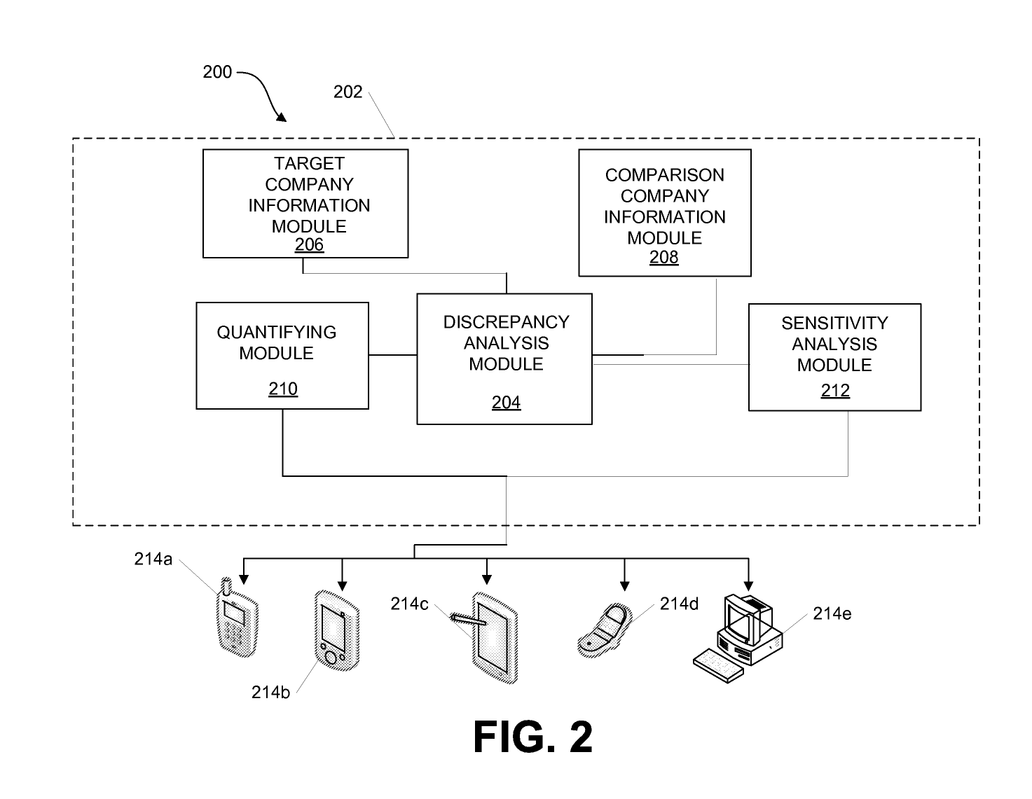

FIG. 2 illustrates one example benefit quantifying system 200 according to one or more aspects described herein. In some examples, the benefit quantifying system 200 may be part of, internal to or associated with an entity 202. The entity may be a corporation, university, government entity, and the like. In some examples, the entity 202 may be a financial institution, such as a bank. Although various aspects of the disclosure may be described in the context of a financial institution, nothing in the disclosure shall be construed as limiting the benefit quantifying system to use within a financial institution. Rather, the system may be implemented by various other types of entities without departing from the invention.

The benefit quantifying system 200 may include a discrepancy analysis module 204. The discrepancy analysis module 204 may receive information from one or more other modules, databases, and the like, in order to identify a discrepancy. In some examples, the discrepancy analysis module may receive target company information from module 206. The target company information may include information about a target company to which the user of the system (for example, entity 202) is attempting to sell a product or service. For example, the information received may include a number of days sales are outstanding, a number of days inventory is generally on hand, a number of days payables are outstanding, a cash conversion cycle/net trade cycle, average amount owed (e.g., to the target company by a vendor, operating working capital as a percentage of sales, operating working capital as a percentage of total capital, and/or cash flow return on invested capital, and the like. Various other types of information may also be received without departing from the invention.

In some arrangements, the target company may be a company that has sent a request for proposal to the entity. In other examples, the target company may be a company that the entity has identified as a potential user of a product or service offered by the entity. The target company information module 206 may be connected to or may include a database storing information such as company contact information, target company financial information (as discussed above), target company accounts payable information, target company accounts receivable information, and the like.

The discrepancy analysis module may also receive information from comparison company information module 208. The comparison company information module 208 may be connected to or may include a database of information about companies other than the target company. For instance, the comparison company information module 208 may include information about companies similar to the target company, competitors of the target company, and the like. The types of information received from the comparison company information module may be similar to the type of information provided by the target company module 206 in order to facilitate a comparison between the information on the target company and one or more other, comparison companies.

In some examples, the discrepancy analysis module 204 may identify an opportunity to provide an impact or benefit to the target company. For example, the discrepancy analysis module 204 may identify a cash flow situation at the target company that could be improved (e.g., target company receiving accounts receivables after long delay, target company making payments too early, and the like). In other examples, the discrepancy analysis module 204 may compare information from the target company to information from another company or companies in order to identify a discrepancy. For example, the discrepancy analysis module 204 may compare the account receivables of the target company to one or more comparison companies (e.g., similar companies, competitors, and the like) to determine whether the comparison companies have an impact or benefit (e.g., positive or negative) that the target company does not. For instance, the discrepancy analysis module may determine that the target company is making a payment to a vendor within 20 days of receiving an invoice, while another company is making a similar payment to a similar vendor within 30 days of receiving an invoice. Accordingly, the discrepancy analysis module 204 has identified a discrepancy of 10 days in which the target company could benefit from holding the payment funds in their own accounts rather than paying it out.

The system 200 may also include a quantifying module 210. The quantifying module 210 may receive a discrepancy from the discrepancy analysis module 204 and may, in some examples, identify one or more products or services to reduce or eliminate the discrepancy and/or quantify the impact or benefit associated with reducing or eliminating the discrepancy. For example, to continue to arrangement described above, the quantifying module 210 may quantify the impact or benefit of the target company holding the cash associated with the payment to the vendor for the additional 10 days (the identified discrepancy). In some examples, the quantifying module 210 may also identify one or more products or services to provide to the target company (e.g., sell) that would aid in reducing or eliminating this discrepancy. In other examples, a standard product or products may be associated with reducing or eliminating the discrepancy and those products or services may be offered, e.g., for sale.

The system 200 may further include a sensitivity analysis module 212. In some examples, the sensitivity analysis module 212 may model the potential impact or benefits of adjusting one or more factors associated with the target company. For instance, if the target company allows customers to make a payment within 30 days of the invoice, it may be advantageous to offer a discount if the customer makes an early payment. Accordingly, the sensitivity analysis module 212 may determine a plurality of discounts to offer for a varying number of days early a payment is made. The module 212 may then quantify the effect of the discount, early receipt of funds, and the like, on the cash flow and/or profit of the target company. This quantified benefit may be used, either with the quantified benefit determined by the quantifying module 210 or on its own, to aid a sales person in selling one or more products or services to the target company.

The quantified benefits, and/or any other additional or desired information about the target company, other companies, and the like, may be output to, or accessible from, one or more computing devices 214a-214e. The computing devices may include a smartphone 214a, a personal digital assistance 214b, a tablet computer 214c, a cell phone 214d, or a desktop or laptop computing device 214e. In some examples, the quantified benefits may be transmitted to one or more computing devices (e.g., as a report). Additionally or alternatively, a user may access the quantified benefit(s) by accessing the system (e.g., by logging in to the system).

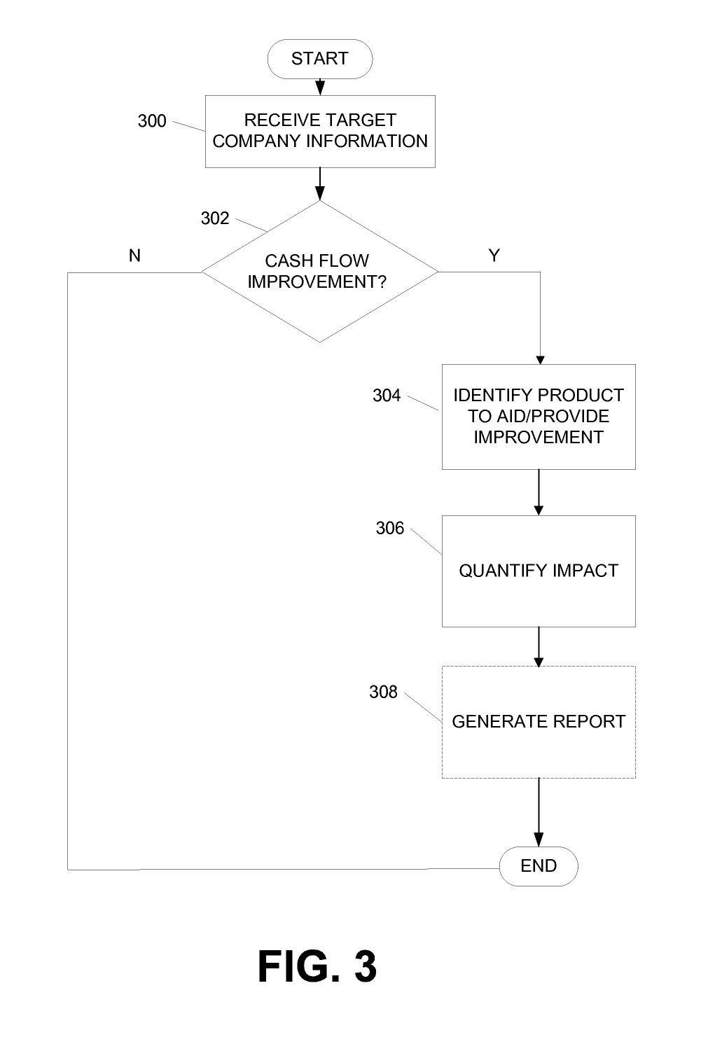

FIG. 3 illustrates one example flow chart of a method of quantifying impact or benefits. In step 300, information about a target company may be received. For instance, an entity (such as entity 202) using or implementing the system (such as benefit quantifying system 200) may receive information about a company to which the entity desires to attempt to sell a product or service. In some examples, this information may be received in response to or in conjunction with receipt of a request for proposal from the target company. In other examples, the target company may be identified internally, by the entity, as a target company to which products and/or services may be sold and information may be received based on that identification.

In step 302, a determination is made as to whether a cash flow improvement is available to the target company, for example, through the use of one or more products or services the entity may be offering to provide to the target company. For example, a potential cash flow improvement may be identified if the target company is receiving payments from customers/clients within a time period greater than a predetermined threshold (e.g., longer than 20 days, longer than 30 days, longer than 45 days, and the like). Additionally or alternatively, a potential cash flow improvement may be identified if the target company is making payments to vendors within a time period less than a predetermined threshold (e.g., in less than 20 days, less than 30 days, and the like). Holding funds that need to be paid out for a longer period of time or receiving funds owed to the target company in a shorter period of time provides greater cash flow and working capital for the target company.

If no cash flow improvements are identified, the process will end. If, alternatively, one or more potential cash flow improvements are identified, one or more products or services to aid in or provide the improvement are identified in step 304. In some examples, the products and/or services may be standard products or services that provide the desired functionality. In other examples, the products or services identified may be identified based on one or more characteristics of the target company, the desired cash flow improvement, and the like.

In step 306, an impact or benefit associated with the cash flow improvement (e.g., based on use/implementation of the product and/or service provided by the entity) may be quantified. For instance, the increase in cash flow or working capital may be calculated based on the received company information (which may include information about accounts payable, accounts receivable, and the like). Accordingly, a savings associated with making payments later or receiving payments earlier may be quantified in order to better understand the benefit to the target company.

In some examples, this and other methods described herein may be used to approach a target company before the target company has identified a need for any product or service to provide this or similar benefits. For instance, before a target company recognizes a need for improvement and/or issues a request for proposal, the entity may compile a company profile of the target company to identify and quantify the improvements available to the target company through use of one or more products or services provided by the entity. That information may then be used when approaching the target company to offer the products or services for sale (e.g., during a sales pitch).

In some examples, a report may be generated providing the quantified impact or benefits, as shown in optional step 308. The report may include graphs, charts, tables, and the like to display the quantified benefit, products and/or services available, and the like.

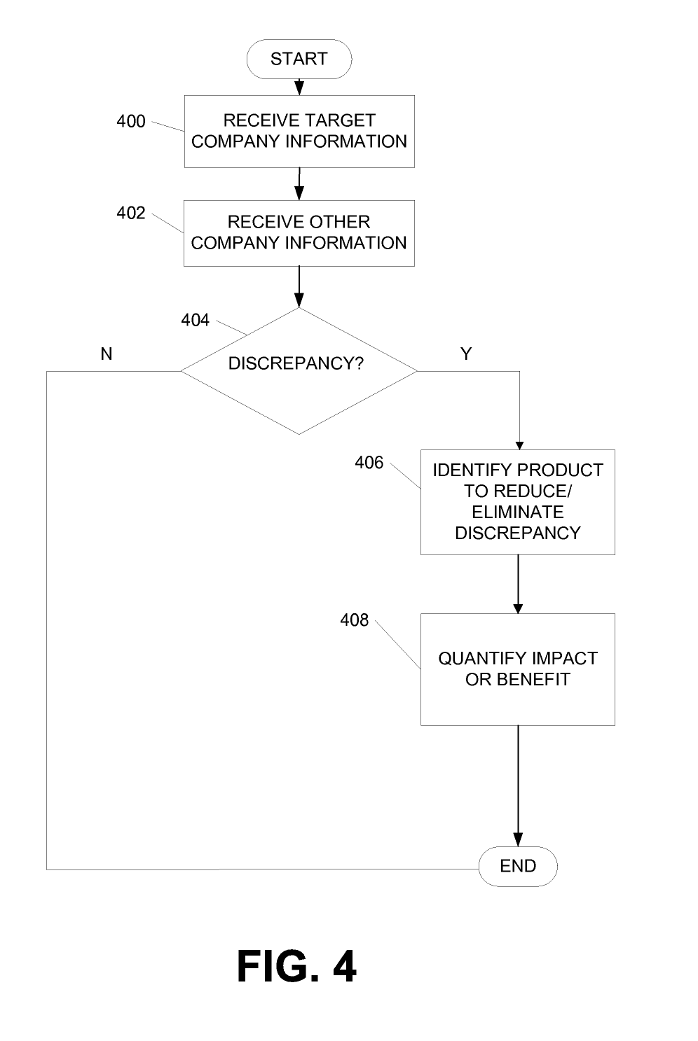

FIG. 4 illustrates another example method for quantifying impact or benefits. In step 400, target company information is received. In some examples, the company information may be received from one or more sources that may, in some examples, be publicly available or accessible. Similar to the arrangement discussed above, the target company information may include accounts payable information, accounts receivable information, general financial information of the target company, and the like. In step 402, comparison company information may be received. The comparison company information received may include information about one or more companies similar to the target company, competitors of the target company, and the like, and may be similar in nature to the information received about the target company in order to determine whether the comparison company is receiving a benefit that the target company is not.

In step 404, a comparison between the target company information and the comparison company information is performed and a determination is made as to whether a discrepancy exists between the target company and the comparison company or companies. For instance, a determination may be made that the comparison company is paying vendors within a 30 day window of time while the target company is paying vendors within 20 days. This yields a gap or discrepancy of 10 days in which the comparison company is seeing increased cash flow/working capital that the target company is not seeing. Accordingly, it may be advantageous to close this gap or remove this discrepancy in order to increase cash flow/working capital for the target company. This is merely one example discrepancy that may be identified. Various other discrepancies may be identified without departing from the invention.

If no discrepancy is identified in step 404, the process may end. Alternatively, if a discrepancy is identified in step 404, one or more products or services available from the entity may be identified that may aid the target company in reducing or eliminating the discrepancy, as shown in step 406. In some examples, the products and/or services identified may be a top number of products that are used by other companies in similar situations to provide impact or benefits. For instance, the products identified may be the top 2 selling products, top 3 selling products, top 4 selling products, and the like. The selection of these products may, in some examples, be automatically performed by the system (e.g., system 200). Additionally or alternatively, an associate or team member may identify one or more products to quantify the impact or benefit of implementing for a particular target company.

In step 408, one or more impacts or benefits of implementing the identified products and/or services may be quantified. For example, the system may identify cash flow improvements based on the use or implementation of the identified products in order to aid in reducing or eliminating the identified discrepancy. This quantified impact or benefit may then be used to illustrate the advantage of implementing the identified products and/or services to the target company, for instance, during a sales pitch. In some examples, the quantified impact or benefits may be actual cash savings, cash flow (on a periodic or aperiodic basis), percentage of working capital increased, potential interest earned, and the like. In some examples, the quantified impact or benefits may be presented in aggregate form such that all products and/or services considered have been quantified together to provide one overall benefit. Additionally or alternatively, each identified product and/or service may be quantified individually and the results may be presented on a product-by-product or service-by-service basis. In some examples, quantifying the impact or benefit may yield a negative outcome, or an outcome less positive than use of another product, service, and the like. Accordingly, this product or service may not be suggested to the potential client based on this quantified impact.

In some examples, the system may also provide a sensitivity analysis as part of quantifying the impact or benefits. For instance, the system may determine whether it would be advantageous to provide a discount as an incentive to receive funds in a shorter time period. For example, it may be advantageous to provide a discount to customers/clients who provide payment earlier than required or earlier than is typical for that customer/client. The system may determine a plurality of time periods for discount and an amount of discount and may determine a benefit associated with the discount and the time period. This benefit may identify the effect of the discount and earlier payment on cash flow and profits of the target company based on the time period and discount factor.

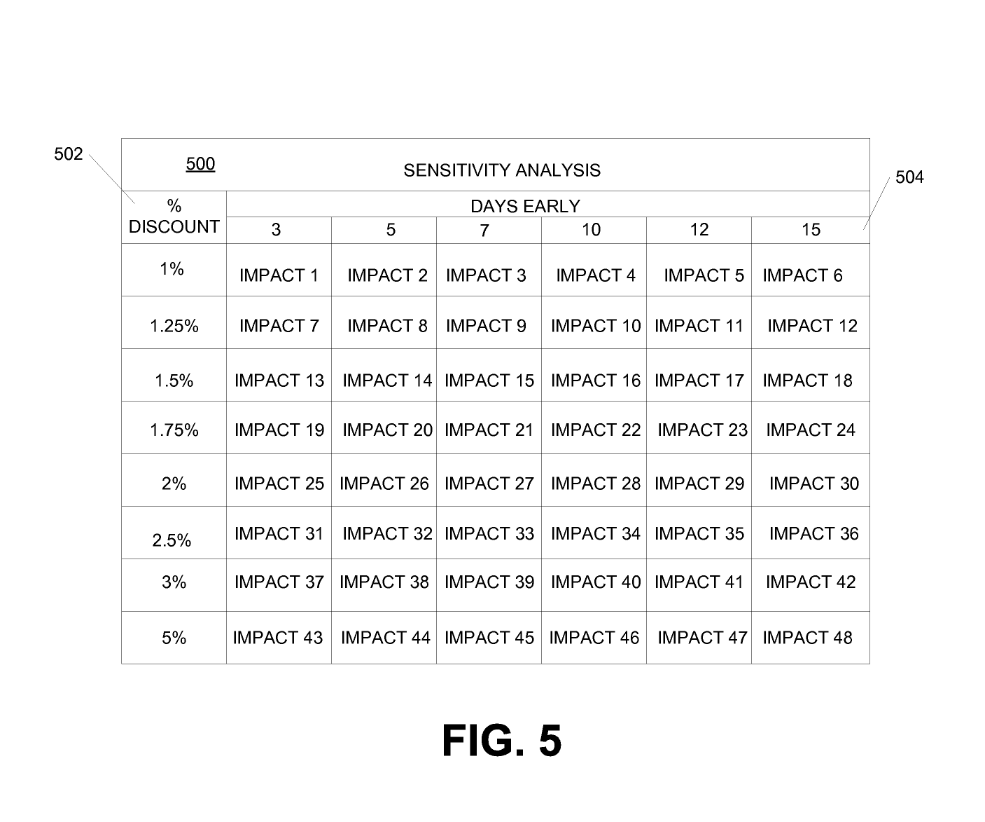

FIG. 5 illustrates one example table identifying impacts or benefits for various discount factors over various time periods. The table 500 includes various discount factors in column 502 and various time periods in row 504. The discount factors and time periods shown are merely examples and nothing in the disclosure should be viewed as limiting various arrangements to only those discount factors and time periods shown. Rather, various other discount factors and/or time periods may be used without departing from the invention.

The table also illustrates an impact identified by the system for the particular discount factor and time period. In some arrangements, the impact may be positive or negative. For example, a discount of 1.5% if a customer/client submits payment 5 days earlier than required would yield impact 14, as shown in table 500. Impact 14 may be a positive benefit or a negative effect. Although various impacts or benefits are illustrated, one or more impact for a particular discount factor and time period may be substantially similar to another discount factor and associated time period. Alternatively, each discount factor and associated time period may yield a different impact. The discount factors and time periods may be applied to particular payments, customers/clients, and the like, associated with the target company. The impacts identified may aid in identifying the effects of the discount factor and early receipt of funds on cash flow and profits of the target company.

In some examples, the discount factors and/or time periods may be consistent for each target company, particular payment, and the like, for which the impact or benefit(s) are determined. Additionally or alternatively, the discount factors and/or time periods may be customized for a particular target company, particular payment associated with the target company, particular customer/client of the target company, and the like.

Quantifying impacts or benefits associated with implementing or using one or more products or services may provide a clearer picture of the advantages of the products and/or services to a potential user. Quantifying impacts or benefits may aid sales associates in identifying just how a product or service can benefit a client, thereby providing a more robust picture of the advantage of buying or using a product or service.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. An apparatus, comprising:
at least one processor; and
memory storing computer-readable instructions that, when executed by the at least one processor, cause the apparatus to:
receive user input identifying a client or potential client of an entity;
receive information associated with the client or potential client;
identify, by the apparatus, an improvement to be made at the client or potential client;
determine, based at least in part on the received information associated with the client or potential client, at least one product to sell to the client or potential client to provide the improvement; and
quantify an impact to the client or potential client of using the product for the improvement.

2. The apparatus of claim 1, wherein identifying an improvement to be made at the client or potential client further includes:
receiving information associated with a comparison company; and
identifying, by the apparatus, a discrepancy between the client or potential client and the comparison company, wherein the discrepancy includes an indication of a benefit received by the comparison company that is not received by the client or potential client.

3. The apparatus of claim 2, wherein the at least one product to sell to the client or potential client is a product to at least reduce the discrepancy.

4. The apparatus of claim 2, wherein the benefit received by the comparison company that is not received by the client or potential client includes increased cash flow from at least one of: accounts payable and accounts receivable.

5. The apparatus of claim 2, wherein the discrepancy includes the comparison company making a payment to a vendor in a longer period of time than the client or potential client making a payment to another vendor.

6. The apparatus of claim 2, wherein the discrepancy includes at least one customer of the comparison company having a different average amount owed to the comparison company than an average amount owed to the client or potential client.

7. The apparatus of claim 2, wherein the comparison company is a competitor of the client or potential client.

8. A method, comprising:
receiving, by a benefit quantifying system, user input identifying a client or potential client of an entity;
receiving, by the benefit quantifying system, information associated with the client or potential client;
identifying, by the benefit quantifying system, an improvement to be made at the client or potential client;
determining, based at least in part on the received information associated with the client or potential client, at least one product to sell to the client or potential client to provide the improvement; and
quantifying, by the benefit quantifying system, an impact to the client or potential client of using the product for the improvement.

9. The method of claim 8, wherein identifying an improvement to be made at the client or potential client further includes:
receiving information associated with a comparison company; and
identifying, by the benefit quantifying system, a discrepancy between the client or potential client and the comparison company, wherein the discrepancy includes an indication of a benefit received by the comparison company that is not received by the client or potential client.

10. The method of claim 9, wherein the at least one product to sell to the client or potential client is a product to at least reduce the discrepancy.

11. The method of claim 9, wherein the benefit received by the comparison company that is not received by the client or potential client includes increased cash flow from at least one of: accounts payable and accounts receivable.

12. The method of claim 9, wherein the discrepancy includes the comparison company making a payment to a vendor in a longer period of time than the client or potential client making a payment to another vendor.

13. The method of claim 9, wherein the discrepancy includes at least one customer of the comparison company having a different average amount owed to the comparison company than an average amount owed to the client or potential client.

14. The method of claim 8, further including,
determining, by the benefit quantifying system, a plurality of discount factors;
determining, by the benefit quantifying system, a plurality of time periods, each of the plurality of time periods being associated with each of the plurality of discount factors in a matrix; and
determining, by the benefit quantifying system, an impact to the client or potential client associated with each of the plurality of time periods associated with each of the plurality of discount factors.

15. One or more non-transitory computer-readable media having computer-executable instructions stored thereon that, when executed, cause at least one computing device to:
receive, by the computing device, user input identifying a client or potential client of an entity;
receive information associated with the client or potential client;
identify an improvement to be made at the client or potential client;
determine, based at least in part on the received information associated with the client or potential client, at least one product to sell to the client or potential client to provide the improvement; and
quantify, by the computing device, an impact to the client or potential client of using the product for the improvement.

16. The one or more non-transitory computer-readable media of claim 15, wherein identifying an improvement to be made at the client or potential client further includes:
receiving information associated with a comparison company; and
identifying, by the computing device, a discrepancy between the client or potential client and the comparison company, wherein the discrepancy includes an indication of a benefit received by the comparison company that is not received by the client or potential client.

17. The one or more non-transitory computer-readable media of claim 16, wherein the at least one product to sell to the client or potential client is a product to at least reduce the discrepancy.

18. The one or more non-transitory computer-readable media of claim 16, wherein the benefit received by the comparison company that is not received by the client or potential client includes increased cash flow from at least one of: accounts payable and accounts receivable.

19. The one or more non-transitory computer-readable media of claim 16, wherein the discrepancy includes the comparison company making a payment to a vendor in a longer period of time than the client or potential client making a payment to another vendor.

20. The one or more non-transitory computer-readable media of claim 16, wherein the discrepancy includes at least one customer of the comparison company having a different average amount owed to the comparison company than an average amount owed to the client or potential client.
